(19) United States
(12) Patent Application Publication
(10) Pub. No.: US 2016/0326888 A1
(43) Pub. Date: Nov. 10, 2016

(54) BLADE

(71) Applicant: ANSALDO ENERGIA IP UK LIMITED, London (GB)

(72) Inventors: Shailendra NAIK, GEBENSTORF (CH); Ivan LUKETIC, UNTERSIGGENTHAL (CH)

(73) Assignee: ANSALDO ENERGIA IP UK LIMITED, London (GB)

(21) Appl. No.: 15/148,756

(22) Filed: May 6, 2016

(30) Foreign Application Priority Data
May 7, 2015 (EP) 15166685.6

(51) Int. Cl. F01D 5/18

(52) U.S. Cl. CPC F01D 5/187; F05D 2220/3215; F05D 2260/941; F05D 2250/75; F05D 2260/22141; F05D 2240/30; F05D 2240/81

(57) ABSTRACT

The blade for a gas turbine includes a root, a platform and an airfoil. The blade further has a cooling channel with an inlet located at the root or platform and outlets. The outlets are located at the platform.

### TECHNICAL FIELD

The present invention relates to a blade; in particular the present invention refers to a blade of a gas turbine; the blade is a long blade positioned at a downstream portion of the gas turbine, e.g. the blade is the blade of the last stage of the gas turbine.

### BACKGROUND

Gas turbines have a compressor for compressing air, a combustion chamber for combusting a fuel with the compressed air generating hot gas, a turbine to expand the hot gas.

The turbine has typically more than one stage, each stage comprising static vanes and rotating blades; the upstream stages closer to the combustion chamber have short blades, whereas the downstream blades further from the gas turbine have long blades (these blades can be so long as 1 meter or even more).

Long blades have a root that is connected to the rotor, a platform delimiting the hot gas path and an airfoil that is immersed in the hot gas passing through the hot gas path.

In order to withstand the demanding working conditions, the blades are provided with a cooling channel through which cooling air is passed.

Traditionally the cooling channel is defined by radial passages having an inlet at the root and an outlet at the tip of the blade.

These traditional blades have some disadvantages.

In fact, the radial configuration of the cooling channels with inlet at the root and outlet at the tip of the blades, causes a pumping effect with compression of the cooling air (i.e. the cooling channels define a centrifugal compressor for the cooling air); the consequence of this pumping effect is energy consumption for compression instead that for providing useful work at the gas turbine shaft. E.g. the amount of energy consumed because of the pumping effect can be as high as 1 MW or more.

In addition, since the airfoil part closer to the platform is cooled by colder air than the airfoil part closer to the tip, stress within the blade (in particular in the airfoil) is generated.

### SUMMARY

An aspect of the invention includes providing a blade that causes reduced energy consumption for pumping effect than the traditional blades.

Another aspect of the invention includes providing a blade having reduced stress induced by the differential temperatures through the blade than the traditional blades.

These and further aspects are attained by providing a blade in accordance with the accompanying claims.

### BRIEF DESCRIPTION OF THE DRAWINGS

Further characteristics and advantages will be more apparent from the description of a preferred but non-exclusive embodiment of the blade, illustrated by way of non-limiting example in the accompanying drawings, in which:

FIGS. 1 through 3 show and example of a blade in an embodiment of the invention;

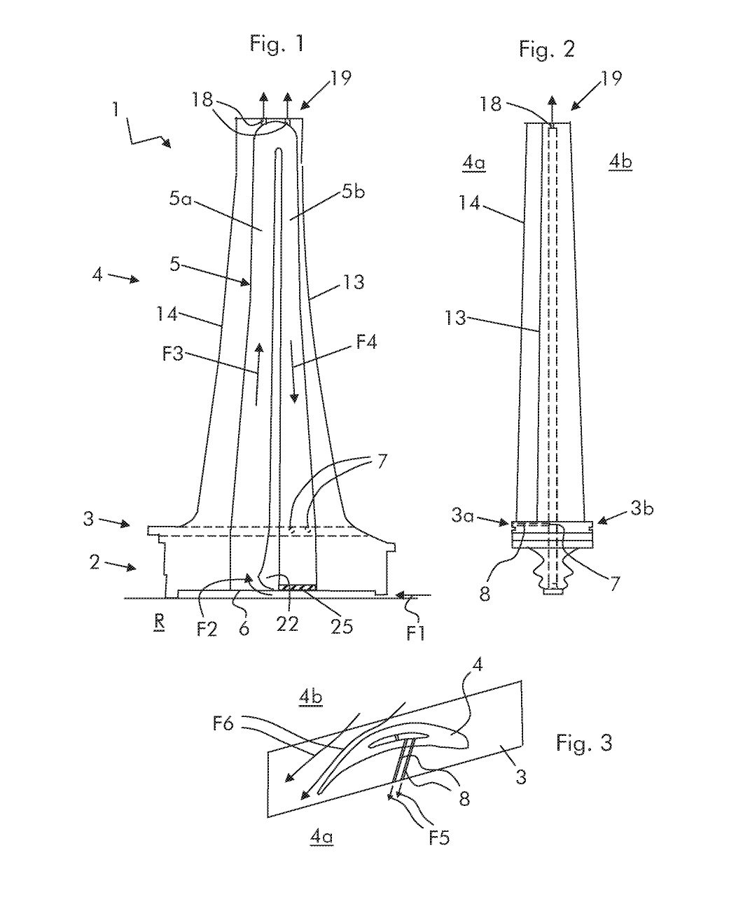

FIGS. 4 and 5 show enlarged portions of FIGS. 1 and 2;

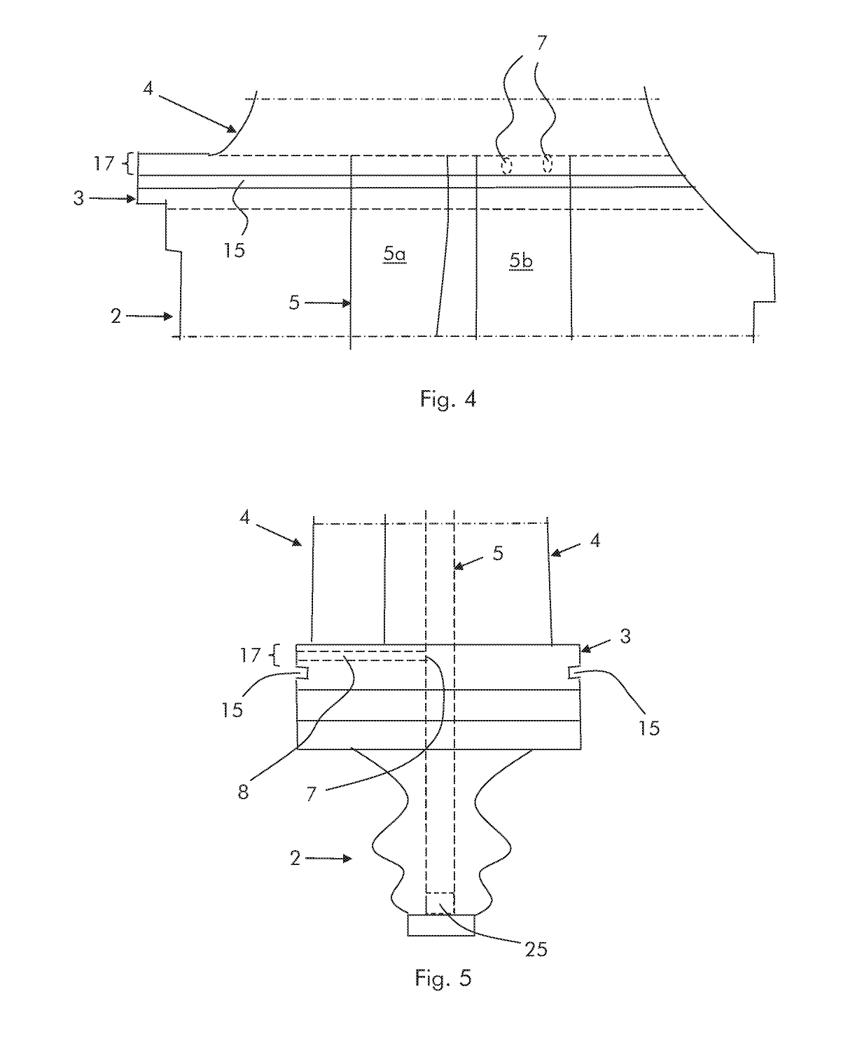

FIGS. 6 through 11 show different configurations of cooling fins,

FIGS. 12 through 14 show different embodiments of the blade.

### DETAILED DESCRIPTION OF EXEMPLARY EMBODIMENTS

With reference to the figures, these show a blade 1 for a gas turbine. The blade 1 comprises a root 2, a platform 3 and an airfoil 4. The blade 4 has a cooling channel 5 with an inlet 6 located at the root or platform and one or more outlets 7.

The outlets 7 are advantageously located at the platform 3.

E.g. the cooling channel 5 can have a U shape. The cooling channel can have one end open to define the inlet 6 and the other end closed by a plate 25, while the outlets 8 are defined at the platform 3. Naturally different embodiments are possible, e.g. the cooling channel can have only one end open to define the inlet 6.

The platform 3 has one or more holes 8; these holes 8 are connected to the outlets 7 of the cooling channel 5 and open on a side of the platform 3.

In particular, the airfoil 4 defines a pressure side 4a and a suction side 4b, and the platform 3 has a platform pressure side 3a facing the pressure side 4a defined by the airfoil 4 and a suction side 3b facing the suction side 4b defined by the airfoil. The holes 8 open on the platform pressure side 3a.

The outlets 7 are closer to the leading edge 13 than to a trailing edge 14 of the airfoil 4.

The platform pressure side 3a and the platform suction side 3b have seats 15 for a seal (the seals are not shown, but typically they are defined by a metal bars inserted in the seats 15 of a platform pressure side 3a and platform suction side 3b of adjacent blades 1.

The holes 8 open in a region 17 of the platform 3 (namely at platform pressure side 3a) between the airfoil 4 and the seat 15.

The blade 1 preferably further comprises one or more second holes 18 between the cooling channel 5 and a tip 19 of the airfoil 4; these second holes 18 are used to cool the tip 19.

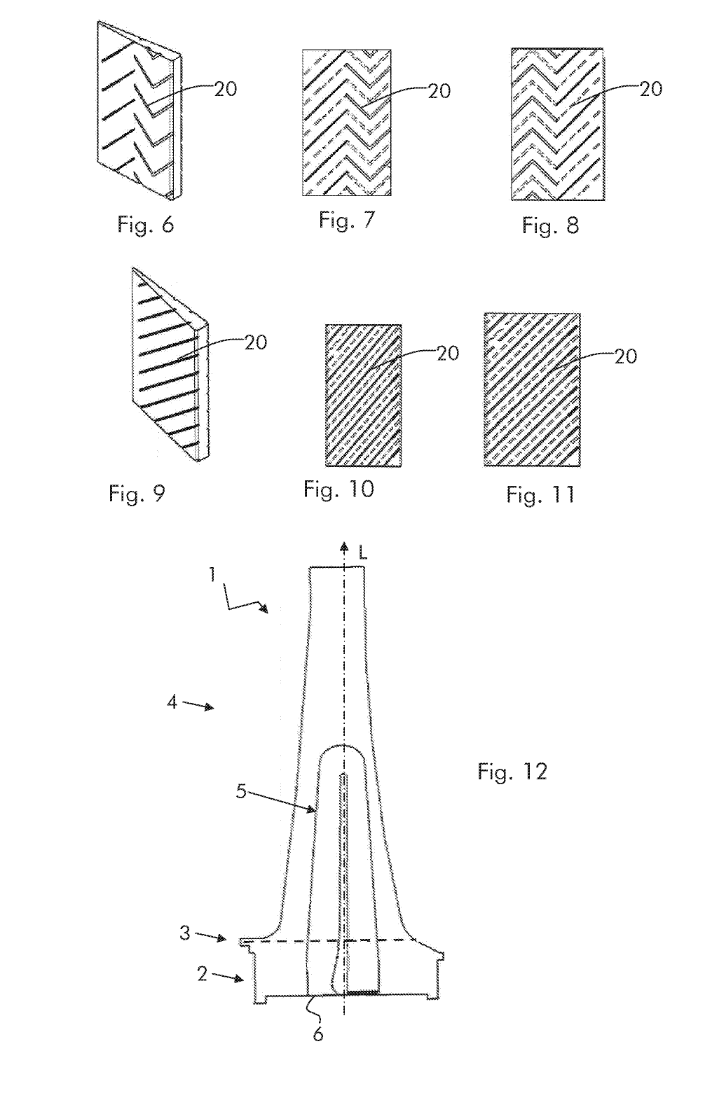

In order to increase cooling, the cooling channel 5 can have cooling fins 20; the fins 20 protrude in the cooling channel 5. Different configurations for the cooling fins are possible, e.g. FIGS. 6-11 show different possible configurations for the cooling fins 20.

The inlet 6 of the cooling channel 5 can have a protruding portion 22 partially obstructing the cooling channel 5. The protruding portion 22 prevents or counteracts formation of recirculation zones for the cooling air at the inlet 6 of the cooling channel 5, so reducing pressure losses.

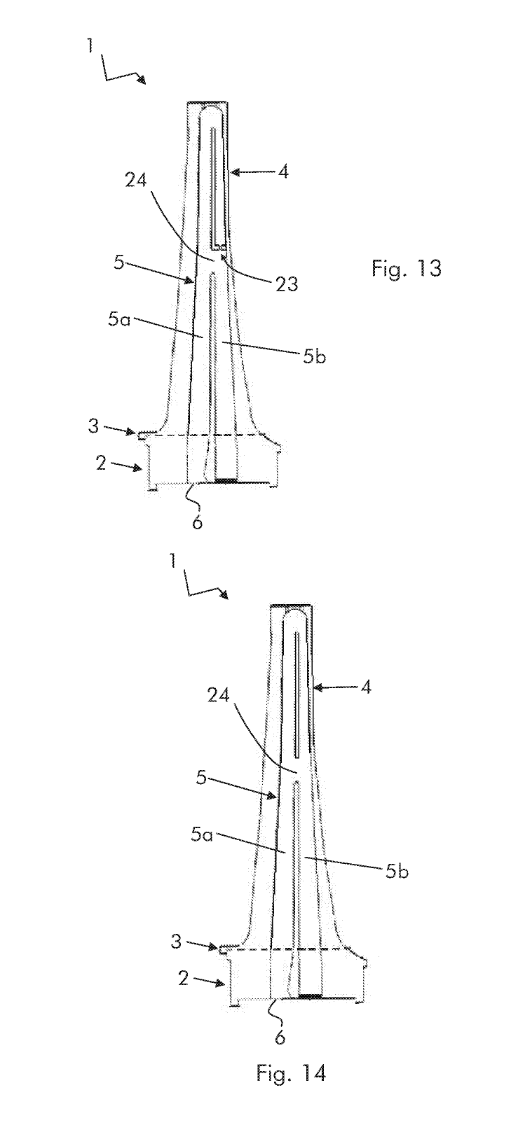

In different embodiments (FIG. 12), the blade 1 can have a cooling channel 5 that partly extends over an airfoil longitudinal length. FIG. 12 shows a longitudinal axis L of the blade 1 and shows that the cooling channel 5 only partly extends through the airfoil 4 of the blade 1 in the direction of the longitudinal axis L.

In another embodiment (FIG. 13), the cooling channel 5 can have one or more restrictions 23. The restrictions 23 can make different amounts of cooling air to pass through different parts of the airfoil 4.

Preferably, the cooling channel 5 has a first path 5a connected to the inlet 6 and a second path 5b connected to the outlets 7; the first and second paths 5a and 5b are connected at ends thereof (i.e. at the tip). The restrictions 23 are defined in the second path 5b.

In still another embodiment, (FIGS. 13 and 14), intermediate passages 24 are provided connecting the first path 5a to the second path 5b.

The blade 1 is a long blade e.g. a blade of a downstream stage of the gas turbine; the longitudinal length of the blade (i.e. the length along the axis L) can have a size of e.g. at least 60 centimetres and preferably at least 75 centimetres and more preferably between 90-120 centimetres.

The operation of the blade 1 is apparent from that described and illustrated and is substantially the following.

During operation the blades 1 rotate immersed in the hot gas.

Cooling air F1 (e.g. drawn from the compressor) is supplied between the blade and the rotor R, and enters the cooling channel 5 (arrow F2); while entering the cooling channel 5 the protruding portion 22 helps reducing the pressure losses.

Thus the cooling air passes through the first path 5a of the cooling channel 5, cooling the airfoil (arrows F3). Some cooling air (a reduced part of the cooling air) passes through the second holes 18 and cools the tip 19.

The cooling air thus passes through the second path 5b of the cooling channel 5 (arrow F4) and reaches the outlets 7. From the outlets 7 the cooling air is discharged to the outside of the cooling channel 5.

While passing through the first path 5a the cooling air is compressed (pumping effect), with energy consumption; in contrast, while passing through the second path 5b the cooling air is expanded, with energy supply. Therefore, since the inlet 6 is at the root 2 or at the platform 3 and the outlets 7 are at the platform 3, the cooling air passage through the cooling channel 5 is substantially neutral, i.e. globally there is no substantial energy consumption due to pumping effect (i.e. compression of the cooling air passing through the cooling channel 5), because inlet 6 and outlets 7 are at the same radial position or at close radial positions with respect to the rotor R, such that no substantial pumping effect can develop.

After entering the holes 8 through the outlets 7 of the cooling channel 5, the cooling air passes through the holes 8 and cools the platform 3 (in particular the part of the platform facing the pressure side 4a of the airfoil 4; arrow F5). The cooling air is then discharged from the holes 8 and, since the cooling air is discharges between the seals housed in the seats 15 and the airfoils 4, the cooling air moves above the platform of an adjacent blade and cools the part of the platform facing the suction side of the airfoil 4b of an adjacent blade 1 (arrow F6).

When the restriction 23 is provided, the restriction 23 can define the amount of cooling air passing through it. FIG. 13 shows and example in which the restriction 23 and the intermediate passage 24 are provided at the same time; in this case the amount of cooling air passing through the different parts of the cooling channel 5 can be optimized according to the cooling needs.

Naturally the features described may be independently provided from one another.

### REFERENCE NUMBERS

1 blade

2 root

3 platform

3a platform pressure side

3b platform suction side

4 airfoil

4a pressure side

4b suction side

5 cooling channel

5a first path

5b second path

6 inlet

7 outlet

8 hole

13 leading edge

14 trailing edge

15 seat

17 region

18 second hole

19 tip

20 cooling fin

22 protruding portion

23 restriction

24 intermediate passage

L longitudinal axis

F1, F2, F3, F4, F5, F6 cooling air

1. A blade for a gas turbine, the blade comprising:
a root, a platform and an airfoil, the blade having a cooling channel with an inlet located at the root or platform and at least an outlet, wherein the at least an outlet is located at the platform.

2. The blade of claim 1, wherein the platform has at least a hole connected to the at least an outlet of the cooling channel, the at least a hole opening on a side of the platform.

3. The blade of claim 2, wherein
the airfoil defines a pressure side and a suction side,
the platform has a platform pressure side facing the pressure side defined by the airfoil and a platform suction side facing the suction side defined by the airfoil, and
the at least a hole opens on the platform pressure side.

4. The blade of claim 1, wherein the at least an outlet is closer to a leading edge than to a trailing edge of the airfoil.

5. The blade of claim 3, wherein
the platform pressure side has a seat for a seal, and
the at least a hole opens in a region of the platform between the airfoil and the seat.

6. The blade of claim 1, comprising:
at least a second hole between the cooling channel and a tip of the airfoil.

7. The blade of claim 1, wherein the
cooling channel has cooling fins.

8. The blade of claim 1, wherein the inlet of the cooling channel has a protruding portion partially obstructing the cooling channel.

9. The blade of claim 1, wherein the cooling channel partly extends over an airfoil longitudinal length.

10. The blade of claim 1, wherein the cooling channel has at least a restriction.

11. The blade of claim 10, wherein
the cooling channel has a first path connected to the inlet and a second path connected to the at least an outlet, and
the restriction is defined in the second path.

12. The blade of claim 1, wherein
the cooling channel has a first path connected to the inlet and a second path connected to the at least an outlet, the first and second paths being connected at ends thereof, and
intermediate passages are provided connecting the first path to the second path.

13. The blade of claim 1, wherein the blade longitudinal size is at least 60 centimetres.

14. The blade of claim 1, wherein the blade longitudinal size is at least 75 centimetres and preferably between 90-120 centimetres.
